(19) United States
(12) Patent Application Publication
(10) Pub. No.: US 2014/0085186 A1
(43) Pub. Date: Mar. 27, 2014

(54) METHOD FOR CONTROLLING MOBILE APPLICATIONS

(71) Applicants: Kari Laurila, Tampere (FI); Marko Luomi, Lempaala (FI)

(72) Inventors: Kari Laurila, Tampere (FI); Marko Luomi, Lempaala (FI)

(73) Assignee: Team Action Zone OY, Tampere (FI)

(21) Appl. No.: 14/009,487

(22) PCT Filed: Apr. 7, 2011
(86) PCT No.: PCT/FI11/50304

§ 371 Date: Dec. 9, 2013

(51) Int. Cl. G06F 3/01

(52) U.S. Cl. CPC G06F 3/01
USPC 345/156

(57) ABSTRACT

A method for controlling mobile applications by using a positioning system. In the method the allowed directions of movement are limited to predetermined directions. The method is configured to select one of the predetermined directions based on a measured direction and then a measured speed of movement is adapted to the selected direction and the mobile application is controlled accordingly.

### FIELD OF THE INVENTION

The invention relates to mobile devices and particularly to controlling applications in mobile devices.

### BACKGROUND OF THE INVENTION

Computer games have been an important industry section for more than 30 years. The development of computers and computing devices has provided huge opportunities for entertainment industry. In addition to conventional computer games, new ways of controlling such games have been introduced. For example, there are games that are controlled by body movements. The body movements are determined by particular controlling devices, machine vision or other suitable means.

Recently, mobile phones have been provided with efficient data processing means. Thus, more complicated games have been introduced for mobile devices. Modern mobile phones typically include global positioning system (GPS), acceleration sensors and other means that can be used in various types of applications. Acceleration sensors are commonly used also in control devices for gaming consoles.

The problem with GPS and other positioning systems is that the accuracy of the system is not always appropriate. In some applications the accuracy is not good enough and in some other applications it is too accurate. Furthermore, in games, movements corresponding exactly to reality are not always desirable as the provided user experience is not the best possible. For example, movements that correspond very well to the reality might cause the game to be too difficult.

### SUMMARY OF THE INVENTION

The present invention discloses a method for controlling an application with a mobile device, wherein the application comprises a predetermined set of directions of movement. A mobile device in the present application means any movable device that has the functionality described below. Examples of such mobile devices are mobile phones, tablet computers, personal digital assistants and similar. In the method, a change in the location of the device is first measured by using a positioning system, wherein the change comprises the direction and the speed of the change. The positioning system may be any positioning system that is capable of indicating the direction and speed of the change. The most common positioning system in currently available mobile devices is GPS; however, the present invention is not limited to that. From the measured change, the direction of movement is selected from a set of predetermined directions based on the measured direction and then the measured speed of the change is adapted to the selected direction of the movement. Typically, said movement is limited by determining boundaries of movement in at least one predetermined direction of movement; however, this is not essential to the present invention.

Typically, the applications controlled by using the control method according to the present invention are games.

In an embodiment of the invention the controlling of the application is calibrated. The calibration may include calibration of the movement in predetermined directions, calibration of a location of the device by using a known location, or calibration of a movement range, such as a playing area. The calibration of the playing area may include determining the limits of the playing area. In an embodiment the movement range is calibrated to correspond with a movement range calibrated with at least one other mobile device.

Typically, the present invention is implemented as a computer program, wherein the computer program is executed in a mobile device comprising suitable means for executing program code and positioning means. When the computer program is executed in a mobile device it is configured to perform the method described above. The computer program may be embodied in a computer readable medium, but in the most typical case it is downloaded from the Internet or it is installed in the mobile device before the sale.

The present invention provides a method for controlling mobile devices by moving the device. A benefit of the present invention is that it is easy to use and it enables a variety of different types of applications to be implemented in a mobile device. Examples of games that can be implemented with the present invention include a game wherein the playing area moves with the player if he/she reaches the boundaries. A sound signal may be played by the mobile device as an indication. The playing area may be an area particularly designed for the game. In that case, the playing area may include actual objects that are part of the game. Alternatively, the objects in the game may be virtual or a combination of virtual and actual objects. The virtual objects may be objects that need to be collected or avoided, for example by dodging.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram of an embodiment of the present invention,

FIG. 2 is an illustration explaining the directions of movement,

FIG. 3 is a method according to an embodiment of the present invention.

### DETAILED DESCRIPTION OF THE INVENTION

Reference will now be made in detail to the embodiments of the present invention, examples of which are illustrated in the accompanying drawings.

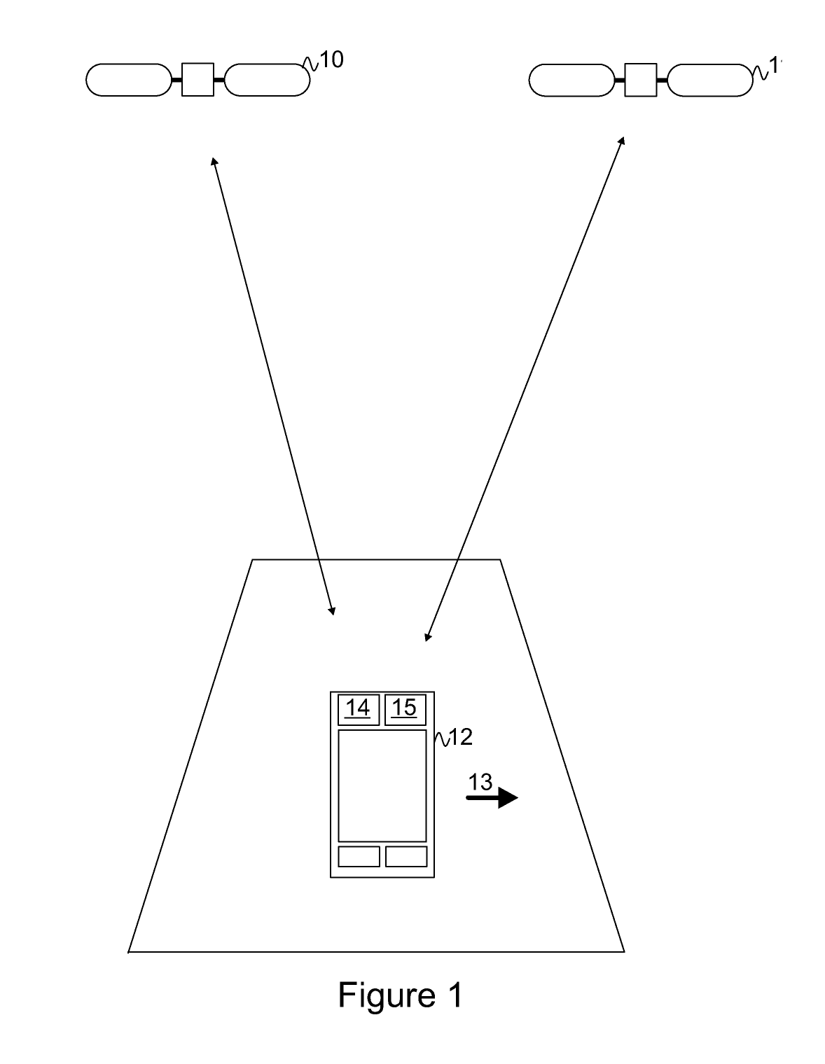

In FIG. 1 a block diagram of an application according to the present invention is presented. In the application according to FIG. 1 a game is played by using a mobile device 10 that has a satellite based positioning system 14 having contact with satellites 11 and 12. In the figure, the player is moving according to the arrow 13. The mobile device 10 further comprises means for executing computer code 15.

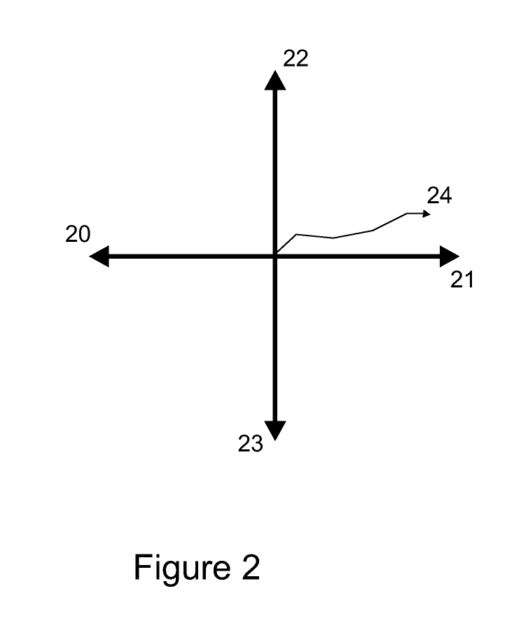

FIG. 2 discloses a set of predetermined directions of movement. the directions are left 20, right 21, forward 22 and backward 23. Arrow 13 of FIG. 1 is represented by arrow 24. It can be seen that it is not exactly any of the predetermined directions.

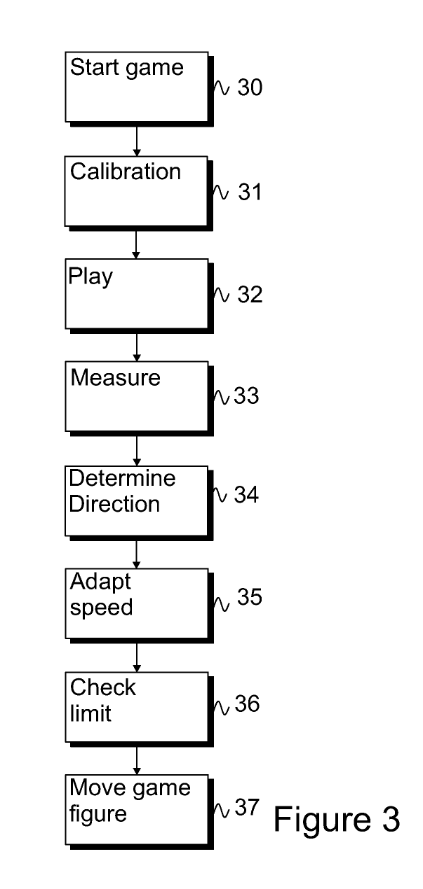

FIG. 3 discloses a method according to the present invention. The method is explained referring to FIGS. 1 and 2. A mobile device of FIG. 1 may comprise a plurality of games and other applications. Thus, playing is initiated by starting the desired application, step 30. Typically, directions of movement have to be calibrated before playing, step 31. The calibration is done by moving the mobile device according to the instructions of the device. For example, if the four directions of FIG. 2 are calibrated the device may first instruct the player to walk right and determines automatically all directions from the player's movement towards right. Other directions may be determined, as they have 90 degree, 180 degree and 270 degree angles with the right direction. In the case where the angles are freely definable by the player, the device may ask the player to walk towards multiple directions. Typically, the required movement is just one or a few steps. This naturally depends on the accuracy of the used positioning system.

In addition to the calibration of the directions of movement it is possible to calibrate the playing area. The playing area may be calibrated for example by walking around it or walking diagonally from the first corner to the second corner, thus determining a rectangle. Playing areas of different shapes are correspondingly possible. For example, a circle may be calibrated by walking the radius of the circle. A polygon sized game area may be defined by setting the outer corners, as an example by walking to the corner positions and pressing a button as an indication. The player may create also a (squirming) path as a game area, by walking the path from one end to another during the calibration.

The player may also freely calibrate multiple physical locations as “game locations”. The player may walk to a position 1, and for example press a button to indicate that this exact position is considered a game location 1. The player may continue to go to multiple real world locations and mark them as corresponding game locations. The state of being close enough to the real world locations is adapted to being at the corresponding game locations. Being close to or at other possible game positions is determined based on the player's position as compared with the calibrated positions.

After calibration the game may be played, step 32. During playing it is likely that the player does not move exactly according to the calibrated directions. The deviation is presented in FIG. 2 by arrow 24. According to the invention these movements are measured by the positioning system, step 33. The measurements indicate that the player has moved according to the arrow 24 of FIG. 2. Thus, the speed of movement in the chosen direction is not as fast as it would be if the player moved to the chosen direction with same speed, as a portion of the movement is oriented in the wrong direction. According to the present invention this is solved by determining the direction to which the player wanted to move. For example, in the FIG. 2 the arrow 24 is closer to the right than forward and thus, it is obvious that the player wanted to move right. The measured speed is adapted to the right. As the result the player moves in the game to the right like the player would be moving exactly to the predetermined direction. The speed of the movement is adapted from the speed of the actual movement, step 35. The adaptation formula depends on the application design. For example, the change may be discrete or include maximum and minimum speeds. These predetermined limits for speed may be different for each of the directions. Furthermore, the limits may be determined in relation to the coordinates. For example, it may be determined that the coordinates cannot exceed 15 meters to the right. In that case the coordinate is not increased even if the player was running to the right after the limit was reached. All these limitations are checked, step 36. When the direction and speed of the movement have been determined and checked the application may be controlled accordingly, step 36.

During the game, a player may move outside the calibrated game area for several reasons. the player may need to move outside, as the current conditions force him or her to do so, for example, because other players are needing the space. The player may also want to move, as he or she finds a nearby area more suitable for playing. In such case, the calibrated game area may follow the player. That is, in the case where the player has reached the end of the game area and continues moving, the game area follows the player so that the “exit point” is locked to the user. With this feature, the player can “carry” the game area with him or her to where ever he or she likes. As the user turns towards the inner game area, the game area stops moving with the player.

The following are examples of features that may be implemented in computer games using a method according the present invention for controlling the game. It must be understood that the following features are just examples and the actual implementation of a game may include one or more of the following features.

Several players can define geographical areas in different parts of the world, and an application such as a game can link the coordinates of these areas together, enabling all players to share the same virtual space. For example: a player in Finland defines a square game area of 100 meters time 100 meters and a player in Guatemala similarly defines a 100 m times 100 m square area. Within an application such as a game both of these areas are combined into one virtual space which the players see on their displays. When both players physically move for example to the center of the square, both players also move to the center of the shared virtual space in the application. This enables several users to play a location-dependent game together in one virtual space, although they physically reside in different places. For example virtual objects placed into the virtual game space are found from the same relative positions in different parts of the world.

Several users can together form a game area. For example, the position of one user is used to define one corner of the rectangular game area and the positions of other users are used to mark other corners. Several users can also walk paths that define the borders of the game area.

Several game areas can be defined adjacent to each other. Users moving outside the borders of one game area enter directly into another game area that can be linked e.g. to completely another game.

Game area size changes can be linked to other parameters such as the running speed of the user, average running speed of all users, volume of shouting, amount of points gathered in the game. The game area may then shrink or increase in size depending on the changes of the parameter.

Part of the users can play totally in the virtual space and part in the real space linked to the virtual space. For example users playing with consoles or PC's can control the movements of their game character with a joystick, mouse or similar. Other players can be in the real space and control the movements of their game characters with their own movement in the real space. All players still share the same virtual space.

In another embodiment of the invention the area defined by the user is considered to be continuous. For example, if the area is rectangular and the player is walking towards right and moves outside the area, he will emerge back to the area from the left side of the rectangle.

Another alternative is that when the user walks out from the game area, a warning signal is created and the user is instructed to return. The user can either continuously proceed out from the game area when he or she walks further, or he or she can be kept in the virtual space all the time at the area border and as soon as he or she turns back he or she is back in the game area.

There can also be several areas defined that are on top of each other. The user can then move inbetween the areas for example by jumping up or kneeling down.

Players may influence the general game events based on their movement in the real world. The game events are defined and extrapolated based on the players' location as compared with the calibrated game area. For example, if a player has created a game path during the calibration, he or she may set the time of the day while playing in the game by walking along the path. The start of the path could be 00:00 and the end of the path could be 24:00. Similarly, in the case where a player is in between two calibrated locations which represent different strengths, he or she may possess more strength the closer he or she is to the calibrated position. If he or she, for example, stands at ⅓ distance to position A and ⅔ to B, he or she may have ⅔ of strength A and ⅓ of strength B.

Players may have a compensation system similar to the handicap used in golf. For example, the game may require lots of running. Faster runners may have a larger game area than slower ones. The same handicap may be applied to all of the objects in the game. The compensation may be manually adjusted or automatically computed from the previous games.

In an embodiment of the invention the invention is implemented as computer software that is configured to execute the method and independent features described above when the computer software is executed in a computing device. The computer software may be embodied in a computer readable medium or distributed in a network such as the Internet.

It is obvious to a person skilled in the art that with the advancement of technology, the basic idea of the invention may be implemented in various ways. The invention and its embodiments are thus not limited to the examples described above; instead they may vary within the scope of the claims.

1-10. (canceled)

11. A method for controlling an application with a mobile device, wherein the application comprises a predetermined set of directions of movement, which method comprises the steps of:
measuring a change in the location of the device by using a positioning system, wherein the change comprises the direction and the speed of the change;
selecting a direction of movement from the set of predetermined directions based on the measured direction; and
adapting the measured speed of the change to the selected direction of movement.

12. The method according to claim 11, wherein the method further comprises a step of limiting said movement by determining boundaries of movement in at least one predetermined direction of movement.

13. The method according to claim 11, wherein the method further comprises calibrating the predetermined set of the directions of movement.

14. The method according to claim 11, wherein the method further comprises calibrating the movement range.

15. The method according to claim 13, wherein calibrating the movement range is configured to correspond with a movement range calibrated with at least one other mobile device.

16. The method according to claim 11, wherein the application is a mobile game.

17. The method according to claim 11, wherein the application is a drawing program.

18. A computer program embodied in a computer readable medium, wherein the computer program comprises a predetermined set of directions of movement and is configured to perform the following steps when executed in a computing device:
measuring a change in the location of the device by using a positioning system, wherein the change comprises the direction and the speed of the change;
selecting a direction of movement from the set of predetermined directions based on the measured direction; and
adapting the measured speed of the change to the selected direction of movement.

19. A mobile device, which device further comprises:
Positioning means;
means for executing mobile applications;
wherein the system is configured to:
measure a change in the location of the device by using a positioning system, wherein the change comprises the direction and the speed of the change;
select a direction of movement from the set of pre- determined directions based on the measured direction; and
adapt the measured speed of the change to the selected direction of movement.

20. The mobile device according to claim 19, wherein the mobile device is further configured to limit said movement by determining boundaries of movement in at least one predetermined direction of movement.

21. The mobile device according to claim 19, wherein the mobile device is further configured to calibrate the predetermined set of the directions of movement.

22. The mobile device according to claim 19, wherein the mobile device is further configured to calibrate the movement range.

23. The mobile device according to claim 22, wherein calibrating the movement range is configured to correspond with a movement range calibrated with at least one other mobile device.

24. The mobile device according to claim 9, wherein the application is a mobile game.

25. The mobile device according to claim 19, wherein the application is a drawing program.
